(19) United States
(12) Patent Application Publication
(10) Pub. No.: US 2004/0236787 A1
(43) Pub. Date: Nov. 25, 2004

(54) Method for determining the effects of manufacturing changes

(76) Inventors: Martin Bohn, Grafenau (DE); Thomas Herkenrath, Wernau (DE); Andreas Pietsch, Herrenberg (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/481,263

(22) PCT Filed: May 31, 2002
(86) PCT No.: PCT/EP02/05990

(30) Foreign Application Priority Data
Jun. 20, 2001 (DE) 101 29 654.1

(51) Int. Cl. G06F 7/00

(52) U.S. Cl. 707/104.1

(57) ABSTRACT

When a physical object with partial objects and design elements is designed, a plurality of design states are typically passed through. The invention relates to a method for automatically selecting further partial objects of a physical object whose designs are affected by differences between two design states of a first partial object of the physical object. In this context, the differences between the design states for a design element are determined. Then, the reference partial objects for the first design element are determined in the first and second design states and the differences between these two sets of reference partial objects are determined. The method is preferably applied for tolerance planning and/or for defining the clamping and securing concept, for example for the body of a motor vehicle and for the devices for designing the body.

### BACKGROUND AND SUMMARY OF THE INVENTION

This application claims the priority of German patent document 101 29 654.1, filed 20 Jun. 2001 (PCT International Application No.: PCT/EP02/05990, filed 31 May 2002), the disclosure of which is expressly incorporated by reference herein.

The invention relates to a method for automatically selecting further partial objects of a physical object, where the designs of the further partial objects are affected by differences between two design states of a first partial object of the physical object. A preferred field of application is tolerance planning for bodies of motor vehicles and devices for their manufacture; the planning comprises a plurality of phases of the process of producing the product, and the designing of the partial objects therefore passing through a plurality of design states.

In what follows, “partial objects” is a generic term for the components, modules, units, assemblies and devices which are to be constructed. Devices, also referred to as geostations, are required to manufacture or assemble other partial objects. All these partial objects together form a “physical object”. “Design elements” is a generic term in particular for “locating points”, “holding points”, “measurement points”, “measurements” and “dimensions”.

During computer-supported design of a physical object which is composed of a plurality of partial objects, tolerances of these partial objects must be defined. This task is referred to as tolerance modeling and is an important part of tolerance planning. It is necessary to determine how the tolerance of each partial object affects the tolerance of other partial objects, and ultimately of the physical object. During tolerance planning it is necessary to determine which tolerances the physical object will have as a function of the tolerances of the partial objects.

For example, tolerances of the physical object or if all the partial objects exhaust their tolerances, are determined using statistical assumptions about the tolerances of the partial objects. Here, it is also necessary to take into account the effects of tolerances on devices which are used during the fabrication and assembly of the partial objects.

A field of application of tolerance planning is the design of the shell of bodies for motor vehicles.

“Tolerance” is understood as the magnitude of the permitted deviation from a predefined value. The international standard ISO 1101 and the German standard DIN 1101 define the term “design and position tolerance” of an element as the zone in which this element (area, axis, central plane) must lie.

Tolerances are related to locating planes. Locating planes are defined by locating points and holding points. Holding points are in particular the points on a clamping device at which components and assemblies are secured in the device. Locating points are in particular holes and elongated holes in the components which have the purpose of holding the component in a device.

Complex physical objects are constructed in parallel by a large number of employees, with specific employees being responsible for specific partial objects. For tolerance planning, these employees have to be provided with information about tolerances. It is necessary to provide each employee with information about “his” partial objects and about the effects of his designing decisions on other partial objects.

During tolerance planning, CAD (Computer-Aided Design) models of the partial objects are usually formed. Information about tolerances is included in CAD models. The assembly sequence is then defined. A tolerance analysis is then carried out, usually by means of tolerance simulations. Commercial tools are available for these steps. Nevertheless, a large amount of work by human employees is necessary for each step.

The results are extensive records with results of simulation runs. A large amount of human work is necessary to obtain the required information for a specific component, and the required information about the effects on other components or on devices. For this purpose it is necessary to look through the records and human employees have to combine results and compare them with the CAD models and the assembly sequence.

Martin Bohn, “Toleranzmanagement im Entwicklungsprozess [Tolerance Management in the Development Process]” Dissertation, University of Karlsruhe, Fakultät für Maschinenbau [Engineering Faculty], 1998, discloses a procedure according to which human employees identify the tolerance-related variables and define the tolerances. These definitions are made continuously through a plurality of phases of the process of producing the product, with various design states. A procedure according to which tolerance simulations are carried out and human employees evaluate the results of said simulations is described. On the other hand, there is no description of how differences between design states are automatically defined, or of how to determine which other partial objects are affected by these differences which apply to a specific partial object.

During computer assisted design, the clamping and securing concept for the physical object also has to be defined. A “clamping and securing concept” often includes a “holding concept”, “orientation concept”, “reference element concept” and/or a “locating point concept”. In particular, a clamping and securing concept determines how, and by means of which devices, partial objects are clamped and secured during assembly.

One object of the invention is to provide a method for selecting further partial objects of the physical object, where the designs of the further partial objects are affected by differences between two design states of a first partial object of the physical object. The method is intended to be carried out automatically by a data processing system; is to be capable of being applied efficiently even for products with hundreds of components; and is intended to facilitate maintaining consistency between designs of the partial objects at the changeover from the first design state to the second design state, and thus the consistency of the design of the physical object. Furthermore, a device for carrying out the method is to be provided.

This and other objects and advantages are achieved by the method and apparatus according to the invention, in which the physical object, which is composed of the first partial object and at least one further partial object, is predefined, each partial object being selectable as a first partial object. A design is generated for the physical object using at least one computer, at least a first and a second design state being passed through during the generation of the design. The two design states can be in particular versions which are arrived at in succession or variants which are generated in a chronologically parallel fashion.

The design of the physical object comprises designing the first partial object and designing the further partial object. The design of each partial object preferably comprises geometric information about the spatial extent and the spatial position of the partial object. In both design states, the design of the first partial object comprises a first design element and geometric information which includes the spatial position. Two assembly sequences define which partial objects are assembled in what sequence using which other partial objects, specifically one assembly sequence for the first design state and one for the second design state. Both assembly sequences contain the first partial object.

The two design states for the predefined first design element are compared with one another. In this context, the geometric properties of the first design element are compared with one another. If a difference is discovered, those partial objects which are affected by definitions for the first design element are determined. The determination is carried out both for the first design state and for the second design state. The influenced partial objects are referred to as “reference partial objects” for the first design element in the first and second design states. The differences between the reference partial objects in the first design state and those in the second design state are defined as differences between the two design states. Here, there is a definition of at least

which further partial objects are reference partial objects only in the first design state; and

which further partial objects are reference partial objects only in the second design state.

In one embodiment of the method according to the invention, the first design element is either a locating point or a holding point. If the first design element is a locating point, all those further partial objects which at least temporarily hold the first partial object at the locating point are determined as “reference partial objects”. If the first design element is a holding point, all those further partial objects which are held at the holding point by the first partial object are determined as “reference partial objects”. Reference partial objects for the first design element are determined in the first and second design states.

The locating point as first design element can affect a plurality of partial objects—specifically in particular if a partial object A holds the first partial object at the locating point, then another partial object holds the partial object A (and thus the first partial object) at the locating point, and so on. The holding point as first design element can also affect a plurality of partial objects, specifically in particular if a partial object A is held at the holding point by the first partial object, then another partial object B is held by the partial object A (and thus by the first partial object) at the holding point, and so on.

According to another embodiment of the invention, the design of the physical object comprises designing the first partial object and at least one further partial object. For the first design state, further partial objects are preselected from those further partial objects which occur before or after the first partial object in the assembly sequence in the first design state. For example, all the partial objects which occur before or after the first partial object in the assembly sequence in the first design state are preselected. Alternatively, only those partial objects which have been evaluated beforehand as important or critical for tolerance planning, which are of a specific type or which originate from a specific manufacturer or whose design has been changed since a predefined date, are preselected.

A preselected partial object is then a reference partial object in the first design state if its design comprises, in the first design state, a further design element which is compatible with the first design element. Correspondingly, reference partial objects are determined for the second design state. In the first and second design states, the same partial objects or different partial objects can be preselected and/or identified as reference partial objects.

In particular, a difference is determined if the first design element is compatible with the further design element in the first design state but not in the second design state, or vice versa. The further partial object is then a reference partial object for the first design element in the first design state, but not in the second design state.

The knowledge of all the reference partial objects in the first and second design states is required in order to identify all the partial objects which are possibly affected by a change in the first design element. Only this knowledge makes it possible to promptly inform the employees processing the reference partial objects which are determined and/or to adapt the design of the reference partial objects to the changes to the first partial object. This helps to make the design of the physical object consistent; that is, it helps to avoid a situation in which the designs of two partial objects do not match one another. If such incompatibilities between the designs of different partial objects are not discovered until after the design process has been finished (for example during fabrication and the assembly of partial objects or even only during operation) then either design modification processes have to be carried out under great time pressure, or partial objects which have already been fabricated have to be subsequently retrofitted.

The method according to the invention discloses a way of finding all the differences between reference partial objects in a reliable, repeatable systematic and quick fashion, and therefore within a short time and in a cost-effective fashion, even if the physical object is composed of hundreds or even thousands of partial objects, or if the designs of these partial objects are generated and changed by a large number of employees. A particularly large advantage is obtained if the employees working on the partial objects work at different locations and chronologically in parallel. Even in this case, designs of a large number of partial objects have to be matched quickly with one another, and yet each employee knows only the designs of a small number of partial objects. The method according to the invention is preferably carried out again after each relatively large modification to a partial object or a design element and/or after a new design state for the design of the physical object has been carried out.

A further advantage of the method according to the invention is that it can be applied early in the process of producing a product. It is not necessary for a design to be generated for each partial object of the physical object even before the method is applied. It is sufficient that designs of the partial objects which follow and precede in the assembly sequence, including those of the reference partial objects, are provided. These designs do not necessarily already need to be generated completely but only to the extent that it is possible to decide which are the reference partial objects and, and to the extent that the comparisons and tests which are provided by the refinements can be carried out.

In this embodiment of the invention, the first design element is not compared with the entire design of a partial object in order to detect whether the partial object is a reference partial object. Instead, it is sufficient for the first design element to be compared exclusively with further design elements of the designs of preselected further partial objects. The method according to this embodiment provides a saving in particular in running time and computer capacity. As a rule, a partial object in fact only has relatively few design elements (for example six locating points and a number of holding points). The saving is achieved because in this method it is not the entire design of a partial object but rather only further design elements which are compared with the first design element. The method is also advantageous because instead of the entire design of the further partial object it is only necessary to generate the further design elements. As a result, the method can be applied earlier in the process of producing a product. Furthermore, the method is advantageous in particular if the physical object comprises a large number of partial objects, and therefore a large number of design elements and/or if a large number of employees work in parallel. One possible reason for the fact that the first design element is compatible with the further design element only in the first design state is that the first design element or the further design element was modified in the second design state without taking into account the effects on the respective other design element, and thus on the further partial object or the first partial object.

The modifications to the first partial object often affect only those partial objects which occur before or after the first partial object in the assembly sequence, but not other partial objects (for example those which therefore occur next to the first partial object in the assembly sequence) because they are associated with a different assembly than the first partial object. For this reason, reference partial objects are preferably looked for only among those partial objects which occur before or after the first partial object in the assembly sequence in the first design state. The same applies to the assembly sequence in the second design state.

One refinement of the invention provides that the design of the first partial object comprises the first design element only in the first design state but not in the second. For example, the first design element was deleted at the changeover from the first design state to the second design state. Preferably, reference partial objects are then determined only in the first design state. No reference partial objects are determined in the second design state because in the second design state there is no first design element, and there are therefore also no reference partial objects for the first design element. The reference partial objects for the first design state are a result of the method. By virtue of this refinement it is possible in particular to determine which partial objects are affected by the deletion of the first design element. Correspondingly, reference partial objects are carried out only in the second design state if the first design element is present only in the second design state.

Preferably two types of reference partial objects are distinguished, namely direct reference partial objects and indirect reference partial objects. Here, a reference partial object is a direct one if no further reference partial object for the first design element occurs in the assembly sequence between the first partial object and a direct reference partial object. Otherwise, an indirect reference partial object is present. At least for a reference partial object which has been determined for the first design element, it is also decided whether such reference partial object is a direct reference partial object or an indirect reference partial object.

The method according to the invention is preferably used for tolerance planning and/or for defining the clamping and securing concept, a holding concept or an orientation concept for a physical object. The method according to the invention is preferably used during the computer-supported design of the physical object.

The following design are preferably used for tolerance planning and/or for defining a clamping and securing concept for the physical object:

A locating point of a partial object is used to define the spatial position of the partial object. In particular, locating points are used to define the spatial position of a component which is installed in an assembly at a specific location. The locating points are preferably the points at which the partial object is secured during the manufacture or the assembly of partial objects. As a rigid body with a spatial extent has six degrees of freedom, preferably six locating points are defined for a partial object, and when necessary auxiliary locating points are defined.

A holding point of a partial object is used to define a point at which the partial object holds another partial object. A holding point of the holding partial object preferably has the same spatial position and spatial orientation as a reference point of the held partial object.

A measurement point on a partial object is associated with a measurement. The measurement point can be the only measurement point or one of a plurality of measurement points, and other measurement points may be associated with the same partial object or with other partial objects.

A measurement on a partial object is defined using one or more measurement points, and is preferably carried out during the fabrication or the assembly of partial objects. Examples of measurements with a single measurement point are point measurements in a specific direction, for example x direction, y direction or z direction. Examples of measurements with two measurement points are distance measurements, gap measurements and offset measurements. An angular measurement is an example of a measurement with three measurement points.

A dimension of a partial object is the distance between two points, straight lines or planes of a partial object.

A design element can be, in particular, a locating point and/or a holding point and/or a measurement point. It can in particular be a measurement and/or a dimension.

The physical object preferably comprises two types of partial objects: on the one hand partial objects which are associated with a further physical object, and on the other hand partial objects which are used as devices or components of devices during the manufacture and the assembly of the first type of partial objects to form the further physical object.

Savings are achieved in terms of time and costs, and faults are avoided, if the further physical object is designed together with the devices for manufacturing it. Modifications to a partial object of the further physical object may affect both other partial objects of the further physical object and partial objects which are devices for manufacturing it or are associated with such devices, and vice versa. For this reason, the refinement provides for effects of modifications to the further physical object on devices, or vice versa, to be determined.

The first partial object is associated with the further physical object, and the further partial object is a device or component of a device; or conversely the further partial object is associated with the further physical object, and the first partial object is a device or component of a device. The further physical object is, for example, a body of a motor vehicle. The further partial object is a device or is associated with a device which is used in the manufacture of the body, and the body is in contact at least temporarily in the first design element.

Various refinements of the invention define which geometric properties of the first design element are compared with one another in the first and second design states.

The spatial position of the first design element in the first design state is compared with that in the second design state. A spatial position is preferably described in each case by means of x, y and z coordinates. As, for example, rounding errors and calculation precisions have to be taken into account, there is a definition of when two spatial positions are evaluated as identical. For example, the Euclid distance between two points which are described by their x, y and z coordinates can be determined. If the distance is smaller than a predefined limit, the points correspond.

Various types of design elements are distinguished. In particular locating points, holding points, measurement points, measurements and dimensions are distinguished. These types can, for example, be differentiated even more finely according to the way of holding or securing a partial object, for example. The type of the first design element for the first design state is compared with that for the second design state. Then, if the types are not identical, a difference is detected.

A design tolerance, position tolerance or dimensional tolerance is defined for the first design element in each of the two design states, preferably in accordance with the international standard ISO 1101 and the German standard DIN 1101. The design tolerance, position tolerance and dimensional tolerance for the first design state is compared with that for the second design state. If the tolerances differ from one another to an extent greater than a predefined limit, a difference is detected.

In each of the two design states the direction which a normal vector of the first partial object has in the first design element is determined for the first design element, that is to say a vector which is perpendicular with the surface of the first partial object in the first design element. This normal vector is also referred to as a spatial orientation or spatial alignment of the first design element. The vector is preferably specified by specifying an x component, y component and z component, and the vector has the length one. The direction of the normal vector in the first design state is compared with that in the second design state. If the directions differ from one another, a difference is detected. Precisely as in the comparison of spatial positions, when vectors are compared a definition is also made of when two vectors are to be evaluated as identical. The comparison of two vectors is carried out, for example, using the Euclid distance.

The first design element is a locating point of the design of the first partial object and contributes to defining the spatial position of the first partial object. In each of the two design states there is a definition of the direction in which the locating point restricts the spatial movement of the first partial object. Not random directions in the space but rather the x direction, y direction or the z direction are preferably specified as restricted directions. There is a comparison of the direction which the locating point restricts in the first design state and the direction which it restricts in the second design state. If the directions differ from one another, a difference is detected.

The first design element is a holding point of the design of the first partial object and thus helps to define the spatial position of a further partial object which is held at the holding point by the first partial object. In each of the two design states there is a definition of the direction in which the spatial movement of the held further partial object is restricted by the holding point. A comparison is made of the direction which the holding point restricts in the first design state and the direction which it restricts in the second design state. If the directions differ from one another, a difference is detected.

Various refinements of the method according to this embodiment define how the first design element and a further design element are compared with one another and how in the process it is checked whether the two design elements are compatible with one another. The refinements define criteria specifying when the design elements are not compatible with one another.

The spatial position of the first design element is compared with that of the further design element. The spatial position is preferably described in each case by an x coordinate, y coordinate and z coordinate. If the spatial position of the first design element does not correspond to that of the further design element, the two design elements are not compatible in the respective design state.

A design tolerance, position tolerance or dimensional tolerance is defined for the first design element and for the further design element in each of the two design states, preferably in accordance with the international standard ISO 1101 and the German standard DIN 1101. In total, four tolerances are therefore defined. The design tolerance, position tolerance or dimensional tolerance of the first design element is compared with that of the further design element. If the tolerances differ from one another, the two design elements are not compatible with one another in the respective design state.

The spatial orientation (that is, the direction of the normal vector of the surface of the first partial object in the first design element) is determined in each of the two design states. In addition, the direction of the normal vector of the surface of the further partial object in the further design element is determined in each of the two design states. The vector is preferably specified by specifying an x component, y component and z component, and the vector has the length one. The directions of the normal vectors are compared with one another; and if they differ, the two design elements are not compatible with one another in the respective design state.

The first design element is a locating point and the further design element is a holding point. In each of the two design states there is a definition of the direction in which the locating point restricts the spatial movement of the first partial object. In addition, in each case there is a definition of the direction in which the holding point restricts the spatial movement of a held partial object. In total, four restrictions are therefore defined. Each restriction is preferably one in the x direction, one in the y direction or one in the z direction. According to an embodiment of the invention, the direction which is restricted by the locating point in the first design state is compared with the direction which is restricted by the holding point in the first design state. Correspondingly, the direction which is restricted by the locating point in the second design state is compared with the direction which is restricted by the holding point in the second design state. If the restricted directions differ, the two design elements are not compatible with one another in the respective design state.

The first design element is a locating point, and the further design element is a holding point. Various ways in which a partial object holds another partial object are distinguished (sometimes referred to as holding concepts). In each of the two design states there is a definition of the way in which the first partial object is held at the locating point by another partial object. In addition, in each of the two design states there is a definition of the way in which the further partial object holds another partial object at the holding point. In total four ways of holding are therefore defined. The ways which are defined for the first design element and for the further design element are compared with one another; and if they differ, the two design elements are not compatible in the respective design state.

The comparisons described above are preferably carried out one after the other. If a comparison reveals that the two design elements are not compatible with one another, the next test is not carried out. If, in all these comparisons, either correspondence is detected or the comparison cannot be carried out due to lack of corresponding geometric properties, the two design elements are compatible with one another.

Design elements are preferably provided with global identifiers which provide highly conclusive information. Then it is possible, in particular, for an employee to infer, from the global identifier of a design element which is specified, for example, on a paper printout, its position and significance. In addition, information about the design element can be derived automatically from an global identifier through a suitable definition.

Such a global identifier of a design element is composed of at least three individual identifiers, specifically

an identifier of that partial object with whose design the design element is associated;

an identifier with which the design element is distinguished from other design elements of the design of the same partial object; and

an identifier for the type of design element.

The identifier for a partial object is composed, for example, of its serial number as well as of a letter which distinguishes components, assemblies, units and devices from one another. The identifier of the type of the design element distinguishes in particular the following types: locating points, holding points, measurements, measurement points, dimensions.

All design elements are preferably provided with such global identifiers and, as a result named in accordance with a uniform nomenclature. As a result, the design elements can easily be found again, for example in results of tolerance simulations, because the names in accordance with the uniform nomenclature are very informative. All the global identifiers for design elements can be generated automatically.

The information which is generated according to the invention and which indicates that the first design element is compatible with the further design element is preferably coded in the global identifier of the first design element and/or of the further design element. According to an embodiment of the invention, a global identifier which refers to the further design element is generated for the first design element. Conversely, according to another embodiment, a global identifier which refers to the first design element is generated for the further design element.

In a repeated application of the method according to the invention, for example at a later time, the global identifier of the first design element is evaluated in order to find a further design element, with respect to which testing is carried out to determine whether it is compatible with the first design element in the second design state. Conversely, the global identifier of a further design element of the design of a further partial object can be evaluated to determine whether it is tested for compatibility with the first design element in the second design state.

The evaluation of global identifiers can be carried out significantly more quickly than a compatibility test which compares, for example, spatial positions or normal vectors. In a particular, the evaluation of global identifiers involves carrying out a preselection among design elements, and only the preselected further design elements are tested for compatibility with the first design element.

The method according to the invention is advantageous in particular if the physical object comprises a large number of partial objects whose designs are generated and changed in parallel by a large number of employees. So that the designs of the partial objects match one another, preferably information about a modification is provided to those employees whose designs are affected by the modification. Therefore, in one refinement, a message is generated which comprises the differences and effects of these differences which are determined according to the invention. The message, with the differences and effects which are determined, is sent to the address of at least one employee whose designs are affected by the modification. This is an employee working on a partial object which is a reference partial object for the first design element only in the first design state or only in the second design state.

In order to find out the address to which such a message is sent, the partial objects of the physical object are linked to addresses. This address is preferably an e-mail address, and the message is sent in electronic form via a message network, for example an Intranet. The linking of partial objects to addresses is preferably generated by automatically linking two tables to one another:

a table which connects each partial object to the employee who is responsible for generating and modifying its design; and

a further table which connects each employee to an e-mail address.

The embodiments of the invention which have been described up to now provide for information about the modifications between the first and the second design states and their effects to be generated. Employees are preferably informed automatically about the modifications and effects. It is then the responsibility of the informed employees to evaluate the information and modify the designs. Working time is saved and the risk of faults is reduced if instead designs of partial objects are automatically updated with design elements, or if a proposal for updating is generated at least automatically.

According to an embodiment of the invention, such updating is carried out if the first and further design elements are compatible with one another in the first design state, but not in the second design state. The updating is carried out with the objective of making the two design elements compatible with one another after the updating, even in the second design state. This refinement significantly reduces the risk of faults and inconsistencies as well of designs with gaps.

In a procedure according to this embodiment, a decision is preferably taken first as to whether the first design element or the further design element is modified. The selected design element is used to modify the spatial position, the normal vector onto the surface of the partial object, the design tolerance, position tolerance or measurement tolerance and/or the type of the design element in such a way that the two design elements are compatible with one another after the modification. A development of the refinement provides for two proposals to be generated:

a first proposal as to how the first design element is modified in such a way that it is compatible with the unmodified further design element; and

a second proposal as to how the further design element is modified in such a way that it is compatible with the unmodified first design element.

After this a decision is preferably taken as to whether one of the two proposals is to be carried out automatically, and if so which proposal is to be carried out.

The method according to the invention provides for a partial object of the physical object to assume the role of the first partial object, and for a design element of the first partial object to assume the role of the first design element. Modifications and effects of the modifications are determined for this first design element in accordance with the invention. A systematic procedure is to carry out this method for all the design elements. The method according to the invention is carried out repeatedly for various design elements.

In a step A), at least one partial object of the physical object for which a design exists, is selected here. In step B), for each partial object selected in step A), at least one design element of the design of this partial object is selected. In the concluding step C), a method is carried out according to an embodiment of the invention in such a way that each of the partial objects selected in step A) assumes the role of the first partial object at least once, and each of the design elements selected in step B) assumes the role of the first design element at least once.

One embodiment provides for, in step A), specific partial objects to be selected, for example all those whose design has been changed or newly generated since a predefined time, or all those which are particularly important or critical according to a previously defined criterion. In addition, specific design elements can be selected, for example all the locating points and holding points. Another embodiment consists in selecting, in step A), all the partial objects of the physical object for which a design exists. In step B), all the design elements of the designs of the selected partial objects are selected. In step C), each of the design elements which are selected in step B) assumes the role of the first design element precisely once.

An important result of such a refinement of the invention can be compiled in a list. This listing comprises all the design elements which have been selected in step B), and between whose design states a difference has been detected. This listing comprises, for each design element, information indicating which differences have been detected between the two design states.

In the tolerance planning for the physical object, tolerance simulations are often carried out repeatedly. A person skilled in the art is familiar with commercial tools for tolerance simulations, for example “variation system analysis (VSA)” from “Engineering Animation, Inc.”

(http://www.eai.com/products/visvsa/classic vsa.html, searched on Jun. 13, 2001) or “Valisys” from “Tecnomatix”

(http://www.valisys.com/marketing/product-desc.html, searched on Jun. 13, 2001). If a plurality of design states are passed through when the design of the physical object is generated, for each design state at least one tolerance simulation is carried out, the designs of the partial objects, in particular the design elements and the assembly sequence in this design state being included in said tolerance simulation. A tolerance simulation for a first design state often supplies a result which differs considerably from the corresponding result in the second design state. For example, the effective tolerance of a measurement or of another design element which is determined by means of the tolerance simulation lies within a predefined tolerance in the first design state, and on the other hand lies considerably outside this tolerance in the second design state.

This observation is an indication that, at the changeover from the first design state to the second design state, modifications have been carried out to partial objects or design elements or the assembly sequence which have led to definitions which are not compatible with other partial objects or design elements. A systematic procedure for finding the causes of this difference is to determine all the partial objects which are influenced by design changes between the first and the second design states.

One refinement of the invention provides this procedure. A precondition is that a tolerance simulation is carried out for the physical object and its partial objects in the first design state and in the second design state, respectively. Then, if a result of the tolerance simulation in the first design state differs considerably from the execution period or the corresponding result in the second design state, a list is generated as described above.

A corresponding systematic procedure is applied if the tolerance simulation in the second design state requires an execution time which is greater by an order of magnitude than in the first design state. For example, the execution time in the first design state is less than a predefined time period, while in the second design state the tolerance simulation is not yet concluded after the expiry of the predefined time period.

The method according to the invention can also be carried out using a computer program product which can be loaded directly into the internal memory of a computer. It comprises software sections with which the method according to the invention can be carried out if the product runs on a computer. In particular, this computer program product can be stored on a web server and transmitted directly into an internal memory of a computer via the Internet or via an Intranet, the computer being a client.

The method according to the invention can also be carried out using a computer program product which is stored on a computer-readable medium and which has computer-readable program means for prompting the computer to carry out the method according to the invention. The medium is, for example, a set of diskettes, of CDs, mini disks or of tapes, or a storage unit which is connected to a PC by means of an interface, for example a USB port or an SCSI interface.

Other objects, advantages and novel features of the present invention will become apparent from the following detailed description of the invention when considered in conjunction with the accompanying drawings.

### BRIEF DESCRIPTION OF THE DRAWINGS

FIG. 1 is a flow diagram of an exemplary embodiment of the method according to the invention;

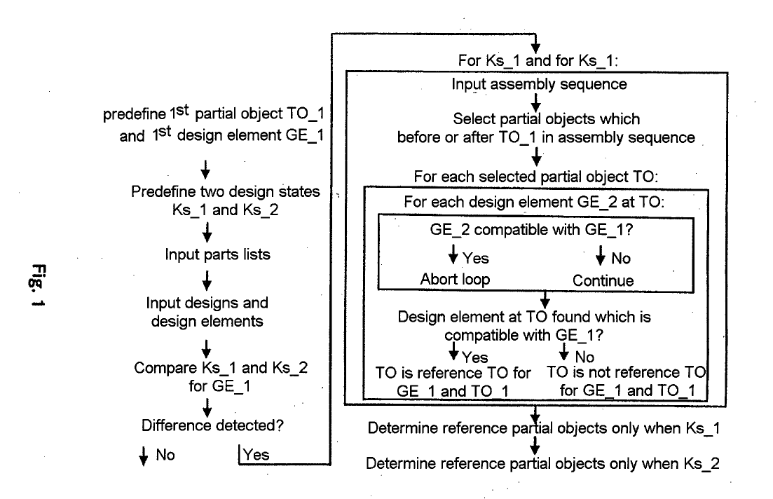

FIG. 2 is an illustration of primary, secondary and tertiary planes of partial objects according to the 3 2 1 principle;

FIG. 3 is an illustration of the specification of tolerances;

FIG. 4 is an illustration of an assembly sequence;

FIG. 5 shows definitions of the six locating points of a component;

FIG. 6 is a reference partial object in the first design state; and

FIG. 7 is a component from FIG. 6 which is not a reference partial object in the second design state.

### DETAILED DESCRIPTION OF THE DRAWINGS

The method according to the invention, which is carried out on a data processing system by means of a computer program, automatically generates information about modifications between two design states of the first partial object and about the effects of these modifications on further partial objects. Input information about the designs of the partial objects including the design elements and about the assembly sequence is acquired automatically for this purpose, and made available to the data processing system. This input information is generated beforehand and stored in data storage devices.

The designs of the partial objects are preferably in the form of CAD models. The data processing system has at least temporarily:

read access to a first data storage device with information indicating the partial objects from which the physical object is made up in the first and second design states, and with management information about these partial objects;

read access to a second data storage device with the CAD models of the physical object and those of the partial objects for the first and second design states;

read access to a third data storage device with a tree structure for the assembly sequence in the first design state, and with the modifications of the assembly sequence in the second design state in comparison with the first design state;

write access to a fourth data storage device in which the information generated according to the invention is stored.

The data storage devices may be, in particular, permanent data stores or main stores of data processing systems. They may, for example, all be associated with the same computer or with different computers which are connected in a local computer network or an Intranet. The data processing system has read access continuously and/or temporarily to the first three data storage devices, and write access continuously or temporarily to the fourth data storage device.

In what follows, there is first a description of the input information with which the three data storage devices are filled and how this information is generated.

In a concept for product data management (PDM), also referred to as engineering data management (EDM), for each design state a parts list is input which comprises the information indicating the partial objects from which the physical object is composed. In addition, management information about the physical object and about its partial objects is input.

A design of the physical object and its partial objects is created. This is carried out by designers of each partial object each creating a CAD model, specifically of both partial objects of the further physical object and devices and their components. A CAD model into which the CAD models of its partial objects are associatively imported is also created of the further physical object in its entirety. The design elements which are required for the tolerance planning are written into these CAD models. “Design elements” is a generic term in particular for locating points, holding points, measurement points, dimensions and measurements on the physical object and its partial objects.

Design elements are defined for the partial objects as part of the design. The design elements include locating points and holding points (that is, the points at which a partial object A of the further physical object is secured and/or held by means of a device or another partial object A of the further physical object while the further physical object is being manufactured). The partial object A is preferably a component, and the other partial object B is an assembly or a device.

Six locating points are required to restrict the six degrees of freedom of a rigid body in space in a statistically determined fashion. The first three locating points cover the primary plane. The next two locating points define the secondary plane which is perpendicular to the primary plane. The last locating point defines the tertiary plane which is perpendicular to the other two planes. The primary, secondary and tertiary planes are perpendicular to one another in pairs. The three planes preferably have parallel axes, i.e. the primary plane is either perpendicular to the x axis or the y axis or the z axis, and the same applies to the secondary and tertiary planes. The primary, secondary and tertiary planes can however also be oriented without parallel axes.

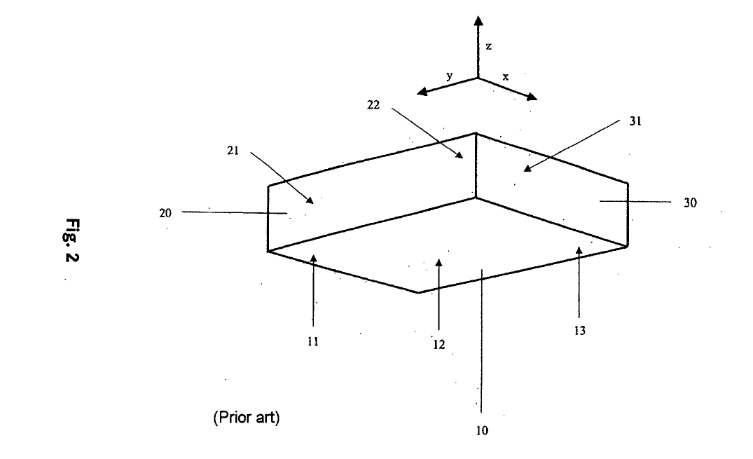

FIG. 2 illustrates the six locating points and the three planes according to the 3-2-1 principle. The primary plane is designated by 10, the secondary plane by 20 and the tertiary plane by 30. The locating points 11, 12 and 13 cover the primary plane 10, the locating points 21 and 22 the secondary plane 20, and the locating point 31 the tertiary plane 30.

It is not necessary to define the further partial objects by which the partial object A is secured at a specific locating point in the first design state and the further partial objects by which it is secured in the second design state. This information is instead determined automatically by the inventive method. These further partial objects are the reference partial objects for the first design element. Direct reference partial objects and indirect reference partial objects are preferably distinguished for the first and second design states, respectively.

Commercially available CAD tools such as CATIA, in conjunction with the tolerance-specific application “functional dimensioning and tolerancing”, permit the user to integrate design elements for tolerance planning into CAD models and to define the tolerances for, and further properties of, these design elements. In particular, in this way it is possible to model locating points, holding points and measurement points. Examples of such design elements with tolerances are a reference point with a positional tolerance in the x direction of a coordinate concept, and the dimension with a tolerance of a component.

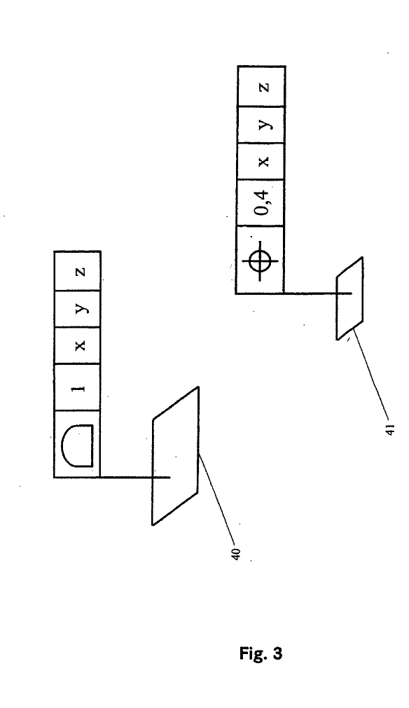

FIG. 3 is an illustration of the tolerance of the profile of a surface 40 (on the left) as well as of the tolerance of a position 41 (on the right). The profile of the real surface must lie within two ideal parallel surfaces with a spacing of 1 mm. The position of the point has a tolerance of □ 0.2 mm in each case, that is to say 0.4 mm in total, in the x, y and z directions.

In addition, definitions of measurements are integrated into the CAD models. The measurements include in particular point measurements in the x direction, in the y direction, in the z direction, gap measurements, angular measurements, offset measurements and distance measurements. For each measurement there is a definition of which measurement points are associated with this measurement.

All these definitions for design elements are related to specific design states and are therefore valid for specific design states. At the changeover from the first design state to the design state, for example additional design elements are added, existing design elements deleted or definitions for design elements, for example tolerances, modified.

One refinement of the invention teaches how the design elements are provided with uniquely defined global identifiers. The refinement provides a nomenclature for the design elements. In order to generate efficiently and quickly the information which is required for the tolerance planning or for the definition of a clamping and securing concept, the partial objects and design elements are inventively provided with global identifiers. These global identifiers, which uniquely characterize the partial objects and design elements, are evaluated automatically in order to generate the information about partial objects and design elements.

The global identifier of a partial object is composed of a uniquely defined identification—preferably the serial number—and an identifying element which indicates whether it is a component, assembly, a device or some other partial object. For example, A stands for a component, Z for an assembly and V for a device.

The global identifier of a design element, and thus of a locating point or holding point, is composed of the following information:

the identifier of the partial object with whose design the design element is associated;

an identifying element indicating the type of the design element (distinguishing in particular locating points and holding points, measurement points, measurements and dimensions); and

where necessary an identifying element in order to distinguish the design element from design elements of the design of the same partial object which are of the same type (that is, to distinguish, for example, different locating points or dimensions of the same component).

For this reason, for a locating point and a holding point, there is also a specification in its global identifier that indicates:

the direction (x direction, y direction or z direction) in which it restricts the spatial movement of the component;

whether it is associated with the primary plane, secondary plane or tertiary plane, which is preferably expressed with numbers from 1 to 6; and

of the type of the locating point or holding point (for example hole, elongated hole or some other point for holding a component or assembly or else a point for orientating or averaging). The identifier also distinguishes whether a locating point is one for holding partial objects directly or indirectly. Direct holding of a component comprises holding it in a device, indirect holding comprises it being held by some other component or an assembly.

Two examples of global identifiers:

A hole on the component with the serial number 1234567, the hole serving as a locating point and restricting the spatial movement of the component in the x direction (1st point secondary plane, therefore 4th restriction) and z direction (tertiary plane), is provided with the global identifier A1234567_L_I_X4Z6. A is the identifying element here for a component, L that for a hole, and I that for indirect holding.

A holding point on the clamping device V1212121 which restricts the spatial movement of a held component in the y direction (1st point primary plane, therefore 1st restriction), is provided with the global identifier V1212121_F_S_Y1. F characterizes here a holding point and S a direct holding.

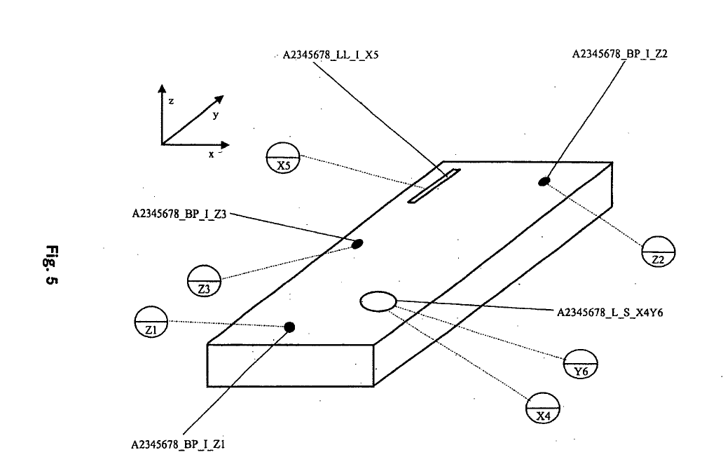

FIG. 5 shows an example of six locating points of a square with the designation A2345678, specifically an elongated hole with one locating point, and a hole with two locating points as well as three other locating points. LL characterizes an elongated hole, L a hole and BP some other locating point. The primary plane is the z plane, the secondary plane the x plane and the tertiary plane the y plane. The circles which are connected to locating points by continuous lines illustrate the definitions for the locating points, and the dashed lines lead from the locating points to the global identifiers according to the invention.

The global identifier of a measurement point is determined as follows: let MP_{—}1 be a measurement point of the design of the partial object TO_{—}1. Let MP_{—}1 be associated with a measurement MES with two measurement points MP_{—}1 and MP_{—}2. Let MP_{—}2 be a measurement point of the design of the partial object TO_{—}2, and TO_{—}2=TO_{—}1 is possible. The global identifier of MP_{—}1 is composed of the following information:

1. the identifier of TO_{—}1,

2. the identifying element that MP_{—}1 is a measurement point and the type of the measurement MES,

3. if there are a plurality of measurement points at TO_{—}1: a local identifying element which distinguishes MP_{—}1 from other measurement points of the design of TO_{—}1, for example a serial number for all the measurement points of the design of TO_{—}1,

4. the identifier of TO_{—}2,

5. if there are a plurality of measurement points at TO_{—}2: an identifying element which distinguishes MP_{—}2 from other measurement points at TO_{—}2.

The 3rd identifying element is a local one because it is uniquely defined only within TO_{—}1.

If the measurement point MP_{—}1 is also associated with a further measurement, the global identifier of MP_{—}1 is correspondingly expanded by adding the identifiers of a further partial object TO_{—}3, and by adding local identifying elements for measurement points of the design of TO_{—}3.

If only one measurement point MP_{—}1 is associated with MES, the global identifier for MP_{—}1 is composed only of the first three information items. A point measurement in the y direction is an example of a measurement with only one measurement point.

The functionalities of currently commercially available CAD tools permit the product designers to integrate measurements into CAD models manually. Various areas which are involved in the product design and manufacture (for example quality management, production planning, pressing facilities, body shell construction and servicing) define which measurement points are associated with this measurement. However, a further refinement of the invention provides for design elements for measurements to be generated automatically. For this purpose, information about measurement points, in particular the global identifiers of the measurement points and information about the assembly sequence is evaluated. This is described in more detail in what follows.

Let MP_{—}1 and MP_{—}2 be the two measurement points of a measurement MES. As described above, the global identifier of the measurement point MP_{—}1 of the design of the partial object TO_{—}1 comprises the identifier of a partial object TO_{—}2, and a local identifying element which distinguishes MP_{—}2 from other measurement points of the design of TO_{—}2. In addition, it is possible to determine automatically from the global identifier of MP_{—}1 the type of the measurement MES, in particular to determine whether MES is a point measurement in the x direction, in the y direction, in the z direction, a gap measurement, an angle measurement, an offset measurement or a distance measurement.

The global identifier of MP_{—}1 is evaluated. A design element for the measurement MES is generated automatically. MP_{—}2 is selected from the measurement points of the design of TO_{—}2. Next, the partial object at which the measurement MES is carried out, and whose design is thus assigned the design element for MES is determined automatically. For this purpose, in the tree structure for the assembly sequence, the nodes for TO_{—}1 and TO_{—}2 are identified and the first node in the assembly sequence which comes after TO_{—}1 and after TO_{—}2 (and therefore stands for the first partial object TO in the assembly sequence in which TO_{—}1 and TO_{—}2 occur together) is sought. The automatically generated design element for MES is assigned to the design of the partial object TO. The global identifier of MES is composed of the following information:

the identifier of TO,

the identifying element indicating the type of the measurement MES,

the identifier of TO_{—}1,

the local identifying element of MP_{—}1,

the identifier of TO_{—}2, and

and the local identifier of MP_{—}2.

An example: let TO_{—}1 and TO_{—}2 be two components with the serial numbers 1234567 and 7654321. Let 1 and 3 be the two local identifying elements for MP_{—}1 and MP_{—}2, MP_{—}1 and MP_{—}2 being associated with the design of TO_{—}1 and TO_{—}2, respectively. Let S be the identifying element for a gap measurement. Let 1425364 be the serial number of the assembly to whose design the measurement is assigned. The design element for the gap measurement between MP_{—}1 and MP_{—}2 is provided with the global identifier Z1425364_S_A1234567_{—}1_A7654321_{—}3.

When a design element for a measurement is generated, a plurality of tests for lack of contradiction (consistency) are carried out automatically, these being specifically:

The global identifier of MP_{—}1 comprises the identifier of TO_{—}2 and a local identifying element which distinguishes MP_{—}2 from other measurement points of the design of TO_{—}2. Does the global identifier of MP_{—}2 conversely comprise the identifier of TO_{—}1 and a local identifying element for MP_{—}1?

Is the same type of identifying element for the type of measurement conversely associated with the global identifier of MP_{—}2? An example: let there be a note in the global identifier of MP_{—}1 that MP_{—}1 is a measurement point of a gap measurement. Is there a note in the global identifier of MP_{—}2 that MP_{—}2 is also associated with a gap measurement?

The above procedure indicating how a design element is generated for a measurement is necessary if MES is a measurement with two measurement points. If only one measurement point is associated with MES (for example in the case of a point measurement in the x direction), the global identifier of MP_{—}1 is composed only of the following information:

the identifier of TO_{—}1,

the local identifying element of MP_{—}1; and

the identifying element indicating the type of the measurement MES.

The design element for MES is generated from this information and assigned to the design of the partial object TO_{—}1.

Further information is assigned to the automatically generated design elements for measurements. The setpoint value of each measurement is automatically obtained from the CAD models with the measurement points of the measurement, for example as a distance between two measurement points or as setpoint value of a measurement point. Employees define tolerances for measurements.

Next, the assembly sequence is defined. The assembly sequence is a tree structure which indicates i) the sequence in which the further physical object composed of partial objects (in particular, components and assemblies) is put together, and ii) which devices are used when. As a rule, the assembly sequence is multi-staged because assemblies are manufactured from the components, and other assemblies are manufactured from these assemblies, and finally the further physical object is manufactured from the latter.

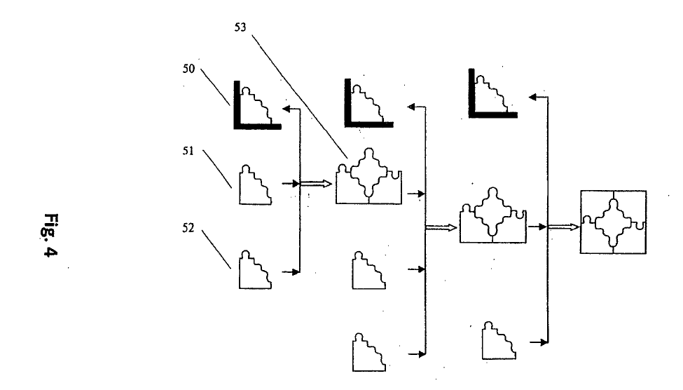

FIG. 4 shows such an assembly sequence. In this example, the component 52 is secured first and then the component 51, in the holding device 50, and the two components 51 and 52 are then permanently assembled to form the assembly 53.

An assembly sequence also applies only for specific design states. At the changeover from the first design state to the second design state, for example additional partial objects for which designs have already been previously generated but which were not yet taken into account in the assembly sequence, are incorporated into the assembly sequence. Alternatively, a partial object is deleted from the assembly sequence at the changeover, or the sequence of partial objects in the assembly sequence is modified.

In the procedure according to the invention, the input information is obtained from the three data storage devices. The determination of differences between the first design state and the second design state and the determination of effects of these differences are described using the example of a component. Let 1234567 be the serial number of this component which assumes the role of the first component of the method according to the invention in the following description. Management information about 1234567 is obtained from the first data storage device.

The method according to the invention is carried out for each of the six locating points of the component in this example. Each locating point assumes in succession the role of the first design element of the method. Reference partial objects whose designs are affected by definitions for the design element are determined here for each locating point. It is necessary to take into account the possibility that the component 1234567 is secured in its six locating points by different partial objects, and that the definitions change at the changeover from the first design state to the second design state. For this reason, it is necessary to determine the respective reference partial objects separately for each locating point of 1234567 and each design state. By means of a read access to the second data storage device there is automatic determination of which locating points are associated with the component 1234567 in the first design state and which in the second design state.

Let GE_1 below be that locating point of 1234567 which assumes the role of the first design element. It is necessary to take into account the possibility that the design of the component 1234567 comprises the locating point GE_1 only in the first design state or only in the second design state. For example GE_1 was supplemented or deleted at the changeover from the first design state to the second design state. For this reason, in the described embodiment of the invention it is firstly tested whether GE_1 is associated with the design of 1234567 in both design states. If this is the case, the two design states for GE_1 are compared. Here, locating points are identified by means of a uniquely defined identifier, preferably the global identifier according to the invention.

The two design states for GE_1 are compared by carrying out a plurality of individual tests. If at least one of these individual tests reveals a deviation, a difference between the design states is determined in step a) of the inventive method, and the steps c) to g) of the inventive method are carried out, and follows:

a) comparing the two design states for the first design element, including geometric properties thereof;

b) if at least one difference has been determined between the two design states for the first design element, executing of steps c) to g);

c) if the first design element is a locating point, determining all further partial objects that at least temporarily hold the first partial object at the locating point in the first design state;

d) if the first design element is a holding point, determining all further partial objects which are held at the holding point by the first partial object in the first design state;

e) if the first design element is a locating point, determining all further partial objects which at least temporarily hold the first partial object at the locating point in the second design state;

f) if the first design element is a holding point, determining all further partial objects which are held at the holding point by the first partial object in the second design state;

g) selecting all further partial objects which have been determined only in the first design state or which have been determined only in the second design state.

If the first design element is present only in the first design state, a comparison between two design states is not possible. Only the steps c) and d) of the method are carried out. Information is acquired on the assembly sequence in the first design state, and the reference partial objects for the first design element are determined in the first design state, and distinguished according to direct reference partial objects and indirect reference partial objects. In this case, the method therefore supplies a list with reference partial objects for the first design state. Correspondingly, the steps e) and f) are carried out if the first design element is present only in the second design state.

If GE_1 is present in both design states GE_1, the following individual tests are carried out:

There is a comparison between the type GE_1 in the first design state and that in the second design state. Different types are locating points, holding points, measurement points, measurements and dimensions. Different types are respectively distinguished in particular for locating points and holding points. If the types differ, a difference is detected.

The spatial position of the first design element in the first design state is compared with that in the second design state. The spatial position is described in each case by an x coordinate, y coordinate and z coordinate. The Euclid distance between the two spatial positions is determined. If it is smaller than or equal to a predefined limit, the two spatial positions correspond.

The spatial orientation of 1234567 in GE_1 in the first design state is compared with that in the second design state. Here, the direction of a normal vector of the component 1234567 in GE_1 is determined for GE_1 in each case. The normal vector in GE_1 is perpendicular to the surface of 1234567. It is specified by specifying an x component, y component and z component and has the length of one. The Euclid distance between the end points of the two vectors is determined. If it exceeds a predefined limit, a difference is detected, otherwise the spatial orientations correspond.

For GE_1, a design tolerance, position tolerance or dimensional tolerance is defined for each of the two design states, specifically in accordance with the international standard ISO 1101 and the German standard DIN 1101. These two tolerances are compared. If the deviation exceeds a predefined limit, a difference is detected.

In each of the two design states there is a definition of the direction GE_1 which the spatial movement of 1234567 restricts. Here, random directions in the space are preferably not specified as the restricted direction but instead the x direction, y direction or the z direction. If the restricted directions differ from one another, a difference is detected.

If the information which is required for one of these individual tests has not been generated or is not available, the individual test supplies a positive result, i.e., no difference is detected.

In order to determine reference partial objects, two sets of candidates are selected (specifically one set of partial objects per design state). Each of these partial objects is examined to determine whether it is a reference partial object. These sets contain only such partial objects which occur in the assembly sequence in the respective design state before or after the component 1234567 as the first partial object. The sets can be restricted further, for example to partial objects, which have been evaluated in advance as important or critical for tolerance planning.

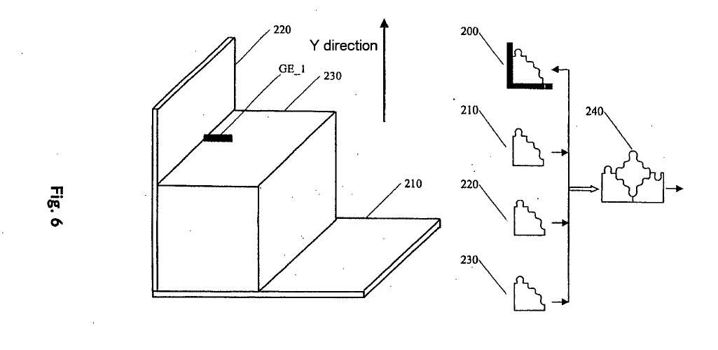

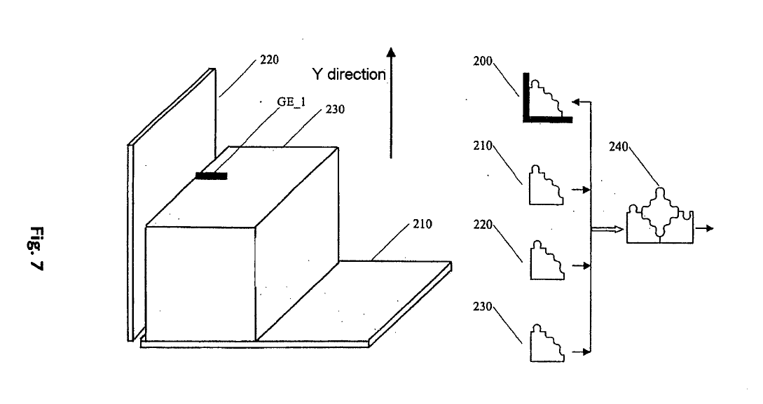

A procedure for carrying out the testing of a candidate comprises comparing GE_1, as the first design element, with the entire design of the partial object. This procedure is illustrated in FIG. 6 and FIG. 7, both of which show a detail from the assembly sequence, which detail corresponds in this example to both design states. The component 230 assumes the role of the first partial object and the locating point GE_1 of the design of the component 230 assumes the role of the first design element. In the first design state to which FIG. 6 relates, the component 220 is a reference partial object for GE_1. In contrast, in the second design state to which FIG. 7 relates the component 220 is not a reference partial object for GE_1. Both results are determined by comparing the spatial position of GE_1 with the design of the component 220.

In more complex physical objects, the first and the second sets can however be composed of hundreds or even thousands of partial objects, and the tests take up a large amount of time. For this reason, GE_1 is instead compared exclusively with previously generated design elements of the designs of partial objects of the first or second set.

Let 7777777 be the serial number of a device which is associated with both sets and is therefore a candidate as reference partial object for GE_1 for both design states. Let GE_2 be a further design element of the design for the device 7777777. For the first and the second design states it is respectively tested whether GE_2 is compatible with GE_1 or not. The testing for compatibility is carried out by successively carrying out a plurality of individual tests. If an individual test supplies a negative result, (i.e., a deviation exists between GE_1 and GE_2), no further individual tests are carried out; rather it is detected that GE_1 and GE_2 are not compatible with one another. If all the individual tests supply positive results (i.e., no deviations), GE_1 and GE_2 are compatible with one another. Each individual test relates either to the first design state or to the second design state.

The individual tests which are carried out during the testing for compatibility correspond on the one hand to those which were carried out during the comparison of the two design states for GE_1, that is:

type of the design elements,

spatial positions,

spatial orientations,

predefined tolerances and

directions in which the spatial movement of a partial object is restricted.

When the types of the two design elements are compared, testing is not carried out for identity but rather for compatibility. If, for example, GE_1 is a locating point and GE_2 is a holding point, the two types are not identical, but compatible.

If these individual tests yield a positive result (that is, do not reveal any difference between GE_1 and GE_2), the following individual tests are also carried out:

If GE_2 is a holding point and there is a definition of the way in which the device 7777777 holds a partial object, this definition is compared with a definition for GE_1 (specifically the definition of the way in which 1234567 in GE_1 is held by another partial object). For example there is a definition that 1234567 in GE_1 is held directly or held in an elongated hole. If the definitions for GE_1 and GE_2 are compatible with one another, the individual test has produced a positive result.

The direction in which GE_1 restricts the spatial movement of 1234567 is compared with the spatial orientation of 7777777 in GE_2, that is to say with the direction of the normal vector of 7777777 in GE_2. If the restricted direction differs from the spatial orientation to a greater extent than a predefined limit, a difference is detected. This limit is, for example, the thickness of the material or the thickness of the wall.

Conversely, the direction in which GE_2 restricts the spatial movement of a partial object which is held by 7777777 in GE_2 is compared with the spatial orientation of 1234567 in GE_1.

Overall, there is therefore a determination of which design elements of the design of 7777777 are compatible with GE_1 in the first design state, and which are compatible in the second design state. If at least one design element of the design of 7777777 in the first design state is compatible with GE_1, 7777777 is a reference partial object for GE_1 in the first design state. The same applies to the second design state.

The method step g) supplies, for example, two lists which combine the results of the determinations described above:

An overview comprises all the further partial objects which are reference partial objects for GE_1 only in the first design state, and all the partial objects which are reference partial objects only in the second design state. The list is sorted, for example, according to the order of occurrence in the assembly sequence in the second design state.

A detailed description lists all the further design elements which are compatible with GE_1 only in the first design state, and all the design elements which are so only in the second design state. For each listed design element there is a specification of which definitions have been modified at the changeover from the first design state to the second design state, and which modifications have led to the design element no longer being compatible, or now being compatible, with GE_1. The design elements are preferably listed in groupings according to the reference partial objects with whose designs they are associated. In addition, they are sorted according to the type of the design element.

In order to increase further the informativeness of the global identifiers and to save computing time when carrying out the method, global identifiers are allocated from which it is apparent with which further design elements a first design element GE_1 is compatible. If compatibility between GE_1 and a further design element GE_2 has been detected for the first design state, the global identifiers of GE_1 and GE_2 are expanded and after the expansion they refer to GE_2 or GE_1.

When design elements which are compatible with GE_1 in the second design state are determined, the global identifiers of GE_1 and the further design elements are analyzed. If a reference to a further design element GE_2 is discovered in the global identifier of GE_1 or if a design element GE_2 is discovered with a global identifier which refers to GE_1, it is verified as to whether GE_2 is also compatible with GE_1 in the second design state.

The expansion of global identifiers for design elements is explained using the example of the component 1234567 which is held, inter alia, by the device 1010101. GE_1 is a locating point of the design of 1234567. GE_2 is a holding point of the design of 1010101. For the first design state it is determined that GE_1 and GE_2 are compatible. Global identifiers are allocated for GE_1 and GE_2 as follows:

The CAD model of the component 1234567 comprises the first design element GE_1 which has the global identifier A1234567_F_S_Y4. From this identifier it is possible to infer that the reference point is associated with the design of the component 1234567, but not the destination objects of this reference point.

The CAD model of the clamping device 1010101 comprises the further reference point REF_{—}2 which firstly has the global identifier V1010101_F_S_Y4.

The global identifier of the further design element GE_2 is expanded in such a way that from the new global identifier it is possible to infer the device with which the holding point (namely V1010101) is associated, the component (namely A1234567) which is held, and how the spatial movement of the component A1234567 is restricted by the holding point. The new global identifier is therefore V1010101_F_S_Y4_A1234567.

The information as to which a partial object holds and secures the component 1234567 at a specific holding point can be recovered automatically from the inventive global identifiers of the first reference point and further reference point, without having to compare the coordinates of reference points with the geometries of partial objects again. Let A1234567_F_S_Y4 be the global identifier of a design element. From the identifier it can be inferred that it is a reference point of the design of the component A1234567. Let V1010101_F_S_Y4_A1234567 be the global identifier of a further design element. From this identifier it can automatically be inferred that the design element is a holding point of the design of the device 1010101 which holds the component 1234567, corresponds to the reference point_{—}4 of the component 1234567 and restricts its spatial movement in the y direction.

This refinement with the inventive global identifiers saves computing time, and requires less computing power if the method for determining destination objects is carried out repeatedly. Geometric information has to be compared only when the method is first carried out, and when it is carried out again global identifiers are compared. When it is carried out again, there is preferably a verification to determine whether the design element which is compatible with the first design element according to the global identifier is actually compatible, or is no longer compatible in comparison with the first time the method was carried out, for example due to modification of the spatial position, spatial orientation or restricted direction.

One development of the invention provides that not only design elements which have already been generated are tested for compatibility, but also new design elements are generated automatically, or definitions for existing design elements are modified in such a way that there is compatibility in the second design state. This is explained using the example of the component 1234567 and the locating point GE_1 which is associated with the design of 1234567. Let 7654321 be the serial number of an assembly which is “almost” in contact in GE_1 in both design states 1234567. “Almost” means the distance between the surface of 7654321 and GE_1 is smaller than a predefined limit in both design states. However, in the first design state the design of 7654321 does not comprise a design element whose spatial position corresponds entirely or “almost” with that of GE_1. In this case, a new design element GE_ new which is associated with the design of 7654321 in the second design state is generated automatically. The spatial position of GE_new is such that GE_new is at the smallest possible distance from 1234567 in the second design state. Definitions are transferred from GE_1 such that GE_1 and GE_new are compatible with one another in the second design state, for example in terms of the type of the design elements, the restricted direction, the spatial movement and/or the spatial orientation.

In the next example, let GE_2 be a design element of the design of 7654321. The spatial position of GE_2 “almost” corresponds to that of GE_1 in both design states. In the first design state, GE_1 and GE_2 are compatible with one another. In the second design state, the spatial orientation of 7654321 in GE_2 (that is, the direction of the normal vector in GE_2), does not correspond to the direction in which GE_1 restricts the spatial movement of the component 1234567. For this reason, GE_1 and GE_2 are not compatible in the second design state. Two proposals are generated automatically. The first proposal lists modifications to the definitions for GE_1, in particular a modification of the direction restricted by GE_1. The second proposal lists modifications to the definitions for GE_2 and for 7654321 whose implementation lead to a modification of the spatial orientation of 7654321 in GE_2. The user decides to accept the first proposal or the second proposal or that neither of the two proposals is implemented. If he decides on the first proposal or the second proposal, GE_1 and GE_2 are compatible with one another in the second design state.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. In a process for designing a physical object, including designing a first partial object and at least one further partial object of said physical object, a method for selecting further partial objects whose designs are affected by differences between two design states of the first partial object; wherein,
the selection is carried out automatically by a data processing system;
a first design state and a second design state are passed through in generating the design of the physical object;
design of the first partial object comprises, in both design states, a first design element which is one of a locating point and a holding point;
geometric properties which comprise the spatial position of the design element are defined for the first design element; and
in each case an assembly sequence is defined for the partial objects in the first and second design states, both assembly sequences comprising the first partial object;
said method comprising:
a) comparing the two design states for the first design element, including geometric properties thereof;
b) if at least one difference has been determined between the two design states for the first design element, executing steps c) to g);
c) if the first design element is a locating point, determining all further partial objects that at least temporarily hold the first partial object at the locating point in the first design state;
d) if the first design element is a holding point, determining all further partial objects which are held at the holding point by the first partial object in the first design state;
e) if the first design element is a locating point, determining all further partial objects which at least temporarily hold the first partial object at the locating point in the second design state;
f) if the first design element is a holding point, determining all further partial objects which are held at the holding point by the first partial object in the second design state; and
g) selecting all further partial objects which have been determined only in the first design state or which have been determined only in the second design state.

2. In a process for designing a physical object, including designing a first partial object and at least one further partial object of said physical object, a method for selecting further partial objects whose designs are affected by differences between two design states of the first partial object; wherein,
the selection is carried out automatically by a data processing system;
a first design state and a second design state are passed through in generating the design of the physical object;
the design of each partial object comprises at least one design element or is expandable by adding at least one design element;
geometric properties which comprise the spatial position of the design element is defined for each design element;
the design of the first partial object comprising a first design element in both design states; and
in each case an assembly sequence is defined for the partial objects in the first and second design states, both assembly sequences comprising the first partial object;
said method comprising:
a) comparing the two design states for the first design element, including geometric properties, thereof;
b) if at least one difference has been determined between the two design states for the first design element, executing steps c) to g);
c) preselecting further partial objects for the first design state, from among those further partial objects which occur in the assembly sequence before or after the first partial object in the first design state;
d) testing for each preselected partial object whether its design comprises, in the first design state, a further design element which is compatible with the first design element, geometric properties of the first design element being compared with geometric properties of at least one further design element of the preselected partial object;
e) preselecting partial objects for the second design state;
f) testing the preselected partial objects for the second design state; and
g) selecting further partial objects whose designs comprise a compatible further design element only in the first design state or only in the second design state.

3. The method as claimed in claim 2, wherein the geometric properties of the first design element and of the further design element comprise at least one of the following information items:
direction of a normal vector in the design element of the surface of that partial object with whose design the design element is associated; and
a design tolerance, position tolerance or dimensional tolerance for the design element.

4. The method as claimed in claim 2, wherein
the first design element is a locating point;
the further design element is a holding point;
the geometric properties of the first design element comprise information which indicates in which direction the locating point restricts spatial movement of the first partial object;
the geometric properties of the further design element comprise information which indicates in which direction the holding point restricts the spatial movement of a held partial object; and
in the compatibility tests in both design states, the direction which is restricted by the locating point is compared with the direction which is restricted by the holding point.

5. The method as claimed in claim 2, wherein
the first design element is a locating point;
the further design element is a holding point;
the geometric properties of the first design element comprise information which indicates how the first partial object is held at the locating point by another partial object;
the geometric properties of the further design element comprise information which indicates how the further partial object holds another partial object at the holding point; and
in the compatibility tests in both design states, in each case the manner of holding which is defined for the locating point is compared with the manner of holding which is defined for the holding point.

6. The method as claimed in claim 2, wherein the first design element is provided with a global identifier comprising:
an identifier of the first partial object;
an identifier with which the first design element is distinguished from other design elements of the design of the first partial object;
an identifier for a type of the first design element;
and if it is detected that a further design element of the design of a further partial object is compatible with the first design element in the first design state;
the global identifier of the first design element is expanded by adding;
an identifier of the further partial object;
an identifier for the type of the further design element;
and an identifier with which the further design element is distinguished from other design elements of the design of the further partial object.

7. The method as claimed in claim 6, wherein during the compatibility testing for the second design states
a further design element is determined by evaluating the global identifier of the first design element; and
only the further design element is tested with the first for compatibility.

8. The method as claimed in claim 2, wherein:
a further design element of the design of a further partial object is provided with a global identifier which includes an identifier of the further partial object, an identifier with which the further design element is distinguished from other design elements of the design of the further partial object, and an identifier for the type of the further design element; and
if it is detected that in the first design state the further design element is compatible with the first design element, the global identifier of the first design element is expanded by adding an identifier of the first partial object, an identifier with which the first design element is distinguished from other design elements of the design of the first partial object, and an identifier for the type of the first design element.

9. The method as claimed in claim 8, wherein during the determination in the second design state:
a further design element is determined by evaluating the global identifier of the further design element by testing whether the global identifier of the further design element comprises an identifier of the first partial object, an identifier for the type of the first design element, and an identifier with which the first design element is distinguished from other design elements of the design of the first partial object;
and the compatibility with the first design element is tested only for said further design element.

10. The method as claimed in claim 2, wherein, if it is detected that in the first design state a further design element is compatible with the first design element, and in the second design state the further design element is not compatible with the first design element, the first and/or the further design elements are modified in the second design state such that, after modification, the first design element is compatible with the further design element in the second design state.

11. The method as claimed in claim 1, wherein the geometric properties used for comparing the two design states, of the first design element comprise at least one of the following information items:
whether the design element is,
a locating point of a partial object;
a holding point of a partial object;
a measurement point on a partial object; or
a measurement on a partial object; or
a dimension of a partial object
a direction of a normal vector in the first design element of the surface of the first partial object;
if the first design element is a locating point, a direction in which the first design element restricts spatial movement of the first partial object;
if the first design element is a holding point, a direction in which spatial movement of a further partial object which is held in the first design element by the first partial object is restricted; and
a design tolerance, position tolerance or dimensional tolerance for the first design element.

12. A computer program product which can be loaded directly into an internal memory of a computer and comprises software sections with which a method as claimed in claim 1 can be executed when the product runs on a computer.

13. A computer program product which can be loaded directly into an internal memory of a computer and comprises software sections with which a method as claimed in claim 2 can be executed when the product runs on a computer.

14. A computer program product which is stored on a medium which can be read by a computer, and which includes computer-readable program which causes the computer to execute a method as claimed in claim 1.

15. A computer program product which is stored on a medium which can be read by a computer, and which includes computer-readable program which causes the computer to execute a method as claimed in claim 2.
